(19) United States
(12) Patent Application Publication
(10) Pub. No.: US 2025/0061183 A1
(43) Pub. Date: Feb. 20, 2025

(54) DEVICE AUTHENTICATION USING LIGHT-BASED COMMUNICATIONS AND CONFIGURABLE SURFACES

(71) Applicant: Dell Products L.P., Round Rock, TX (US)

(72) Inventors: Shree Rathinasamy, Round Rock, TX (US); Maxim Balin, Gan - Yavne (IL)

(21) Appl. No.: 18/450,064

(22) Filed: Aug. 15, 2023

(51) Int. Cl. G06F 21/44; H04B 10/116

(52) U.S. Cl. CPC G06F 21/44; H04B 10/116

(57) ABSTRACT

Methods, apparatus, and processor-readable storage media for device authentication using light-based communications and configurable surfaces are provided herein. An example computer-implemented method includes obtaining at least one authentication request comprising at least one identifier of at least one device and generating at least one control signal to configure one or more characteristics of a configurable surface located in a physical environment based at least in part on the at least one identifier of the at least one device. The method also includes emitting, in the physical environment at least one encoded message for the at least one device using one or more light sources using the configurable surface, and determining whether to authenticate the at least one device based at least in part on information transmitted by the at least one device in response to the at least one message.

### BACKGROUND

Device authentication is frequently used as a mechanism to increase security in networks and/or computing environments. For example, networks often use device authentication as part of an onboarding process so that one or more devices can operate within the networks. An authentication process is an important security factor as devices often store and/or process sensitive data, which can be compromised or stolen by unauthorized devices.

### SUMMARY

Illustrative embodiments of the disclosure provide techniques for device authentication using light-based communications and configurable surfaces. An exemplary computer-implemented method obtaining at least one authentication request comprising at least one identifier of at least one device and generating at least one control signal to configure one or more characteristics of a configurable surface located in a physical environment based at least in part on the at least one identifier of the at least one device. The method also includes emitting, in the physical environment, at least one encoded message for the at least one device using one or more light sources, and modifying the emitted at least one encoded message using the configurable surface based at least in part on the at least one control signal. The method also includes determining whether to authenticate the at least one device based at least in part on information transmitted by the at least one device in response to the at least one message.

Illustrative embodiments can provide significant advantages relative to conventional authentication techniques. For example, technical problems associated with authenticating devices are mitigated in one or more embodiments by implementing an authentication process that uses light-based communications and configurable surfaces. Such embodiments are capable of securely authenticating devices in locations where radio frequency waves cannot be used, for example.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for device authentication using light-based communications and configurable surfaces in an illustrative embodiment.

FIG. 2 shows an example of a light-based transceiver in an illustrative embodiment.

FIGS. 3A through 3C show an example of an edge architecture for onboarding devices in an illustrative embodiment.

FIG. 4 shows an example of a multi-stage onboarding process in an illustrative embodiment.

FIG. 5 shows a flow diagram of a process for device authentication using light-based communications and configurable surfaces in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Security is an important aspect of modern computing environments. For example, edge computing environments (including telecommunications networks) are often highly distributed and decentralized with devices and/or components deployed in locations that are vulnerable to physical security threats. Such threats can include theft, vandalism, and unauthorized access, which can compromise the availability and/or security of the computing environment. Telecommunications networks are frequently targeted by malicious attackers as they often process and transmit sensitive data (e.g., related to personal information, financial transactions, confidential business information, etc.).

A secure onboarding process is an important factor in protecting these and other types of networks from such attacks as it can help ensure that data processed by these devices can be accessed by authorized users. Additionally, many industries (including the medical, financial and insurance industries) have regulatory requirements related to data privacy and security. A secure onboarding process can help organizations comply with such requirements.

Conventional onboarding techniques are often implemented using radio frequencies (RF). However, RF-based techniques are not suitable and/or cannot be used for edge computing environments. One or more embodiments described herein can at least partially mitigate at least some of these issues by providing a secure onboarding process based on visible light communication (VLC) technology and configurable surfaces.

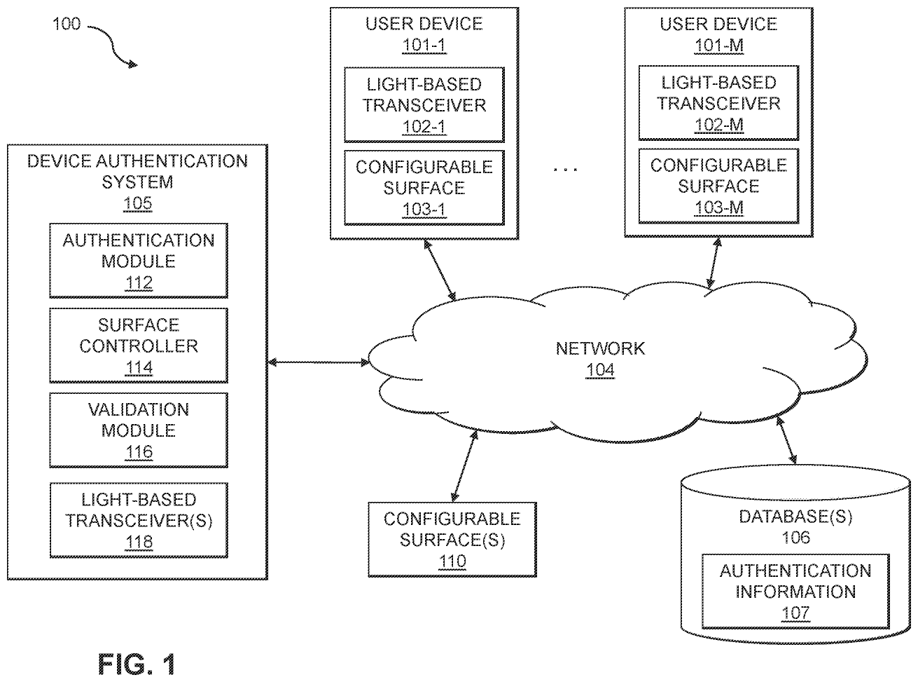

FIG. 1 shows a computer network (also referred to herein as an information processing system) 100 configured in accordance with an illustrative embodiment. The computer network 100 comprises a plurality of user devices 101-1 . . . 101-M (collectively referred to herein as user devices 101) having respective light-based transceivers 102-1, . . . 102-M (collectively referred to herein as light-based transceivers 102) and respective configurable surfaces 103-1, . . . 103-M (collectively referred to herein as configurable surfaces 103). The user devices 101 are coupled to a network 104, where the network 104 in this embodiment is assumed to represent a sub-network or other related portion of the larger computer network 100. Accordingly, elements 100 and 104 are both referred to herein as examples of “networks.” but the latter is assumed to be a component of the former in the context of the FIG. 1 embodiment. Also coupled to network 104 is a device authentication system 105 and one or more configurable surfaces 110.

The term “configurable surface” in this context and elsewhere herein is intended to be broadly construed so as to encompass, for example, any structure that can be programmed to control one or more characteristics of electromagnetic waves, including light waves. For example, the one or more characteristics can correspond to properties such as reflection, refraction, and/or wavelength which can be controlled by changing the electric and magnetic properties of at least a portion of the configurable surface. Configurable surfaces include surfaces that are commonly referred to as reconfigurable intelligent surfaces (RISs) or meta-surfaces, as non-limiting examples.

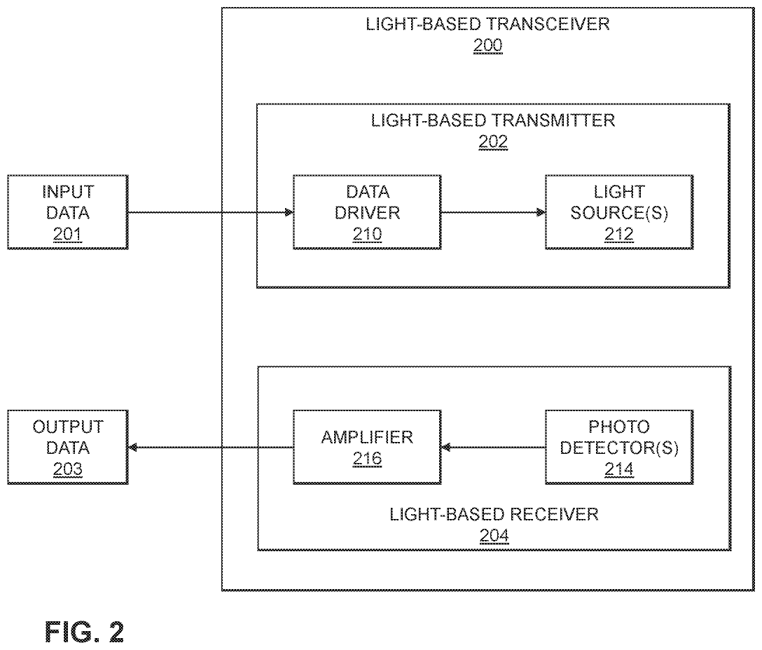

It is assumed that each of the light-based transceivers 102 in the FIG. 1 example comprise a light-based transmitter and a light-based receiver, as described in more detail in conjunction with FIG. 2, for example. In some embodiments, the light-based transceivers 102 may comprise light fidelity (LiFi) transceivers that enable bidirectional wireless communications based on light. For example, each of the light-based transceivers 102 may comprise one or more light sources (e.g., LED and/or infrared light sources) that are used for such communications. It is generally assumed that a given light source emits light within one or more portions of the visible light spectrum, the infrared spectrum, and/or the ultraviolet spectrum. As a non-limiting example, some embodiments can utilize light having wavelengths between 380 nm to 780 nm.

The user devices 101 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 101 in some embodiments comprise respective computers associated with a particular company, organization, or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a LiFi, Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the device authentication system 105 can have at least one associated database 106 configured to store data pertaining to, for example, authentication information 107 for onboarding one or more of the user devices 101. For example, the authentication information 107 may indicate different wavelengths of light that are to be used by respective ones of the user devices 101 for light-based communications.

An example database 106, such as depicted in the present embodiment, can be implemented using one or more storage systems associated with the device authentication system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the device authentication system 105 are one or more input-output devices, which illustratively comprise keyboards, displays or other types of input-output devices in any combination. Such input-output devices can be used, for example, to support one or more user interfaces to the device authentication system 105, as well as to support communication between device authentication system 105 and other related systems and devices not explicitly shown.

Additionally, the device authentication system 105 in the FIG. 1 embodiment is assumed to be implemented using at least one processing device. Each such processing device generally comprises at least one processor and an associated memory, and implements one or more functional modules for controlling certain features of the device authentication system 105.

More particularly, the device authentication system 105 in this embodiment can comprise a processor coupled to a memory and one or more network interfaces.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The one or more network interfaces allow the device authentication system 105 to communicate over the network 104 with the configurable surfaces 110 and/or the user devices 101, for example. The one or more network interfaces illustratively comprise one or more conventional transceivers and/or one or more light-based transceivers 118. The one or more light-based transceivers 118 can be implemented in a manner similar to that of light-based transceivers 102, for example.

The device authentication system 105 further comprises an authentication module 112, a surface controller 114, and a validation module 116.

Generally, the authentication module 112 comprises functionality for obtaining and processing authentication requests sent by the user devices 101.

The surface controller 114 is configured to generate one or more control signals that are transmitted to the one or more configurable surfaces 110. The configurable surfaces 110 can be implemented in a similar manner as configurable surfaces 103, for example. In some embodiments, a given configurable surface 110 can be controlled using one or more control signals generated by the surface controller 114 for modifying one or more characteristics of light emitted by one or more light sources. As a non-limiting example, one or more of the lights sources can be associated with one or more physical environments, and/or the device authentication system 105 may implement one or more of the light sources. The term “physical environment” in this context and elsewhere herein is intended to be broadly construed so as to encompass one or more designated areas (e.g., one or more spaces, buildings, structures, and/or portions thereof) having one or more light sources that enable communications over a light-based communications network (e.g., a LiFi network).

In some embodiments, the modified light can be used as a first part (or stage) of an authentication process for onboarding one or more of the user devices 101. In at least one embodiment, user device 101-1, for example, may filter light emitted by one or more of the light sources (or possibly modify light emitted by its light-based transceiver 102-1) using its at least one configurable surface 103-1.

The validation module 116, in some embodiments, can obtain a digital key from a given one of the user devices 101. The digital key can then be used in a second stage of the authentication process, as described in more detail elsewhere herein. Accordingly, at least some embodiments described herein can provide a multi-stage authentication process for onboarding of user devices 101.

It is to be appreciated that this particular arrangement of elements 112, 114, 116, and 118 illustrated in the device authentication system 105 of the FIG. 1 embodiment is presented by way of example only, and alternative arrangements can be used in other embodiments. For example, the functionality associated with the elements 112, 114, 116, and 118 in other embodiments can be combined into a single module, or separated across a larger number of modules. As another example, multiple distinct processors can be used to implement different ones of the elements 112, 114, 116, and 118 or portions thereof.

At least portions of elements 112, 114, 116, and 118 may be implemented at least in part in the form of software that is stored in memory and executed by a processor.

It is to be understood that the particular set of elements shown in FIG. 1 for device authentication system 105 involving user devices 101 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the device authentication system 105, the configurable surfaces 110, and the at least one database 106 can be on and/or part of the same processing platform.

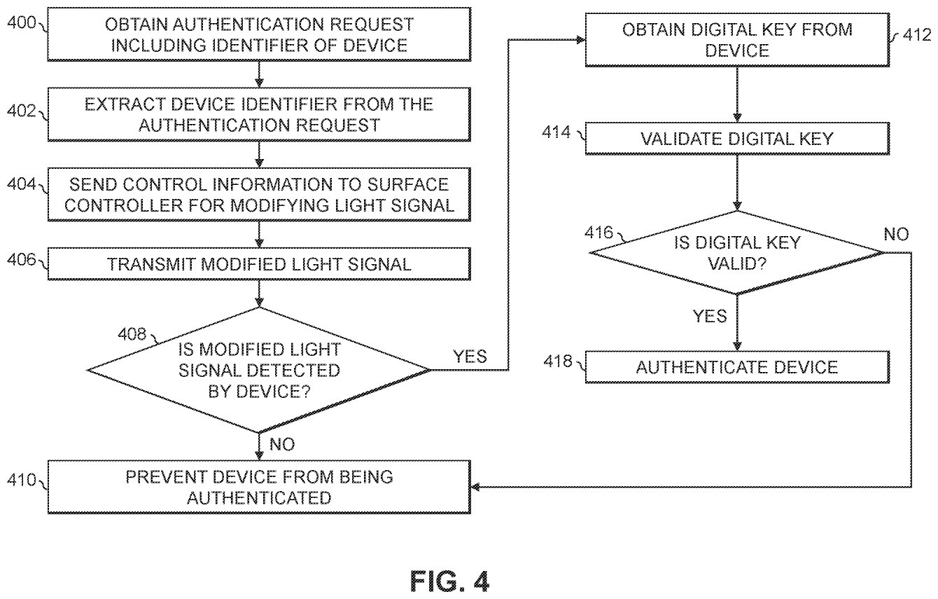

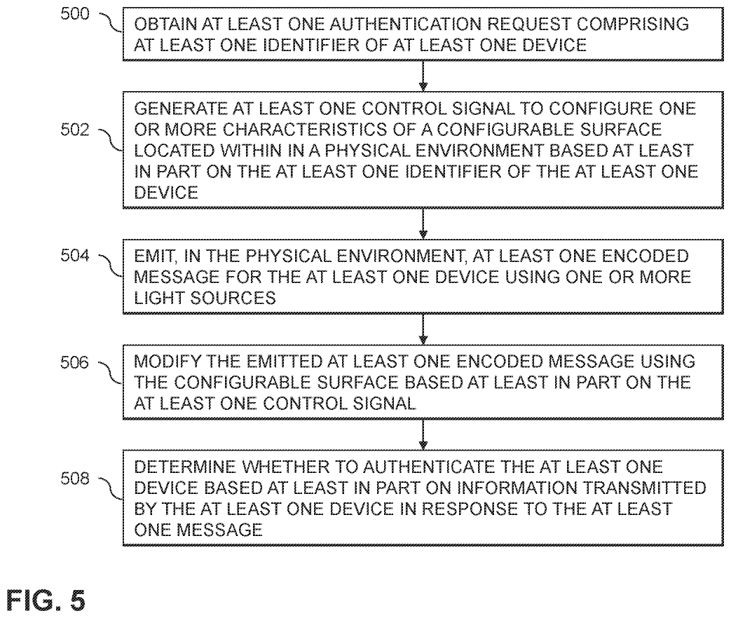

An exemplary process utilizing elements 112, 114, 116, and 118 of an example device authentication system 105 in computer network 100 will be described in more detail with reference to, for example, the flow diagrams of FIGS. 4 and 5.

FIG. 2 shows an example of a light-based transceiver 200 in an illustrative embodiment. In this example, the light-based transceiver 200 includes a light-based transmitter 202 and a light-based receiver 204. The light-based transmitter 202 includes a data driver 210 that obtains input data 201. Generally, the data driver 210 converts the input data 201 into a binary format so that it can be transmitted via one or more light sources 212. For example, the data driver 210 can implement one or more types of modulation schemes in order to transmit the input data 201. As non-limiting examples, at least one of the light sources 212 can be controlled to emit light having different intensity levels to indicate different values (e.g., a first intensity level can indicate a first binary value and a second intensity level can indicate a second binary value). In some examples, the different intensity levels are controlled so that the flickering of the light is not discernable by the human eye.

It is to be appreciated that the light-based transceiver 200 can be implanted in a LiFi system, which can utilize one or more types of modulation schemes (such as one or more types of single carrier modulation schemes and/or one or more types of multiple carrier modulation schemes). It is also to be appreciated that the one or more light sources 212, in some embodiments, can include overhead lighting and/or other types of lighting fixtures.

The light-based receiver 204 includes one or more photo detectors 214 that are configured to detect and convert light emitted by one or more light sources 212 (e.g., of another transceiver 200) into electrical signals. In some embodiments, an amplifier 216 can be configured to amplify, demodulate, and decode the electrical signals in order to recover data transmitted by a light-based transmitter of another device, for example. The recovered data is then provided as output data 203.

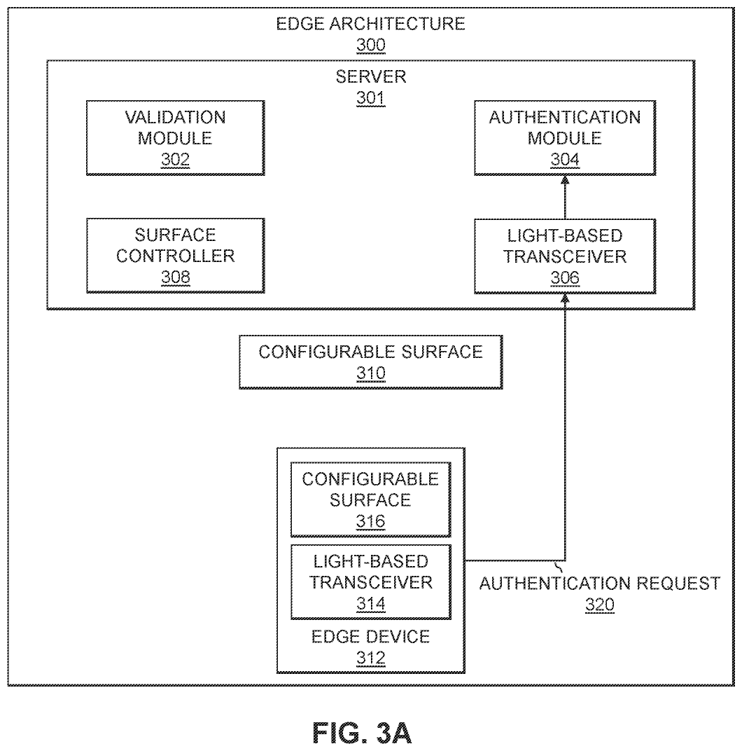

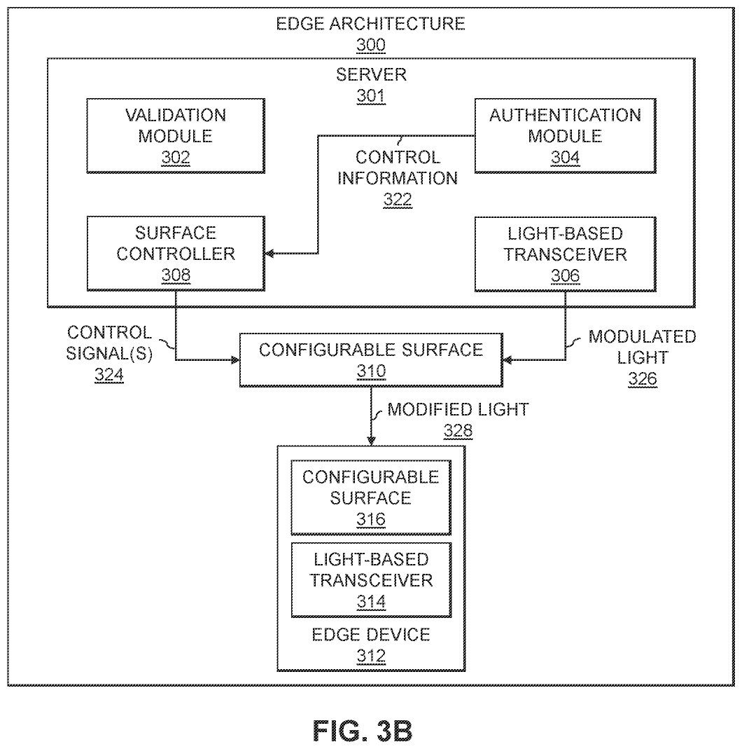

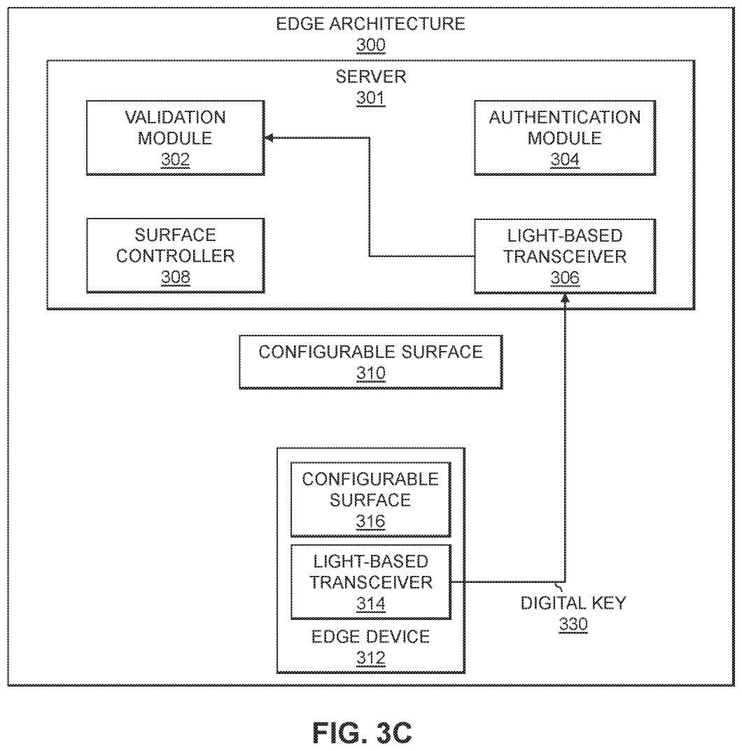

FIGS. 3A through 3C show an edge architecture 300 in an illustrative embodiment. The edge architecture 300 includes a server 301, a configurable surface 310, and an edge device 312. In some embodiments, the server 301 can implement at least a portion of the device authentication system 105, and the edge device 312 can be implemented in a manner similar to a given one of the user devices 101. Thus, in this example, the server 301 includes a validation module 302, an authentication module 304, a light-based transceiver 306, and a surface controller 308, and the edge device 312 includes a light-based transceiver 314 and a configurable surface 316.

In the edge architecture 300 shown in FIG. 3A, it is assumed that the edge device 312 is to be onboarded by the server 301. For example, the edge device 312 may be a new device that has just been powered on. It is also assumed that the server 301 and the edge device 312 are configured to communicate with each other using their respective light-based transceivers 306 and 314.

In FIG. 3A, the edge device 312 initially transmits an authentication request 320 so that the edge device 312 can be authenticated by the server 301. The authentication request 320 is transmitted by the light-based transceiver 314 in the form of modulated light. In some embodiments, the authentication request 320 can include a unique device identifier (ID). For example, the device ID may be designated by a manufacturer of the edge device 312. In at least some examples, the device ID can correspond to a medium access control (MAC) address, serial number, or some other ID that uniquely identifies a given device.

The light-based transceiver 306 of the server 301 obtains the authentication request 320 and recovers the information in the authentication request 320 (including the device ID) and provides it to the authentication module 304. In some embodiments, the authentication module 304 can maintain information related to the authentication request 320, such as a mapping between the device ID of the edge device 312 and at least one parameter that is to be used by the edge device 312 for receiving and/or transmitting light-based communications within the edge architecture 300. By way of example, the at least one parameter may correspond to a property of light, such as wavelength, frequency, intensity, and/or polarization.

Although FIG. 3A shows one server 301, one configurable surface 310, and one edge device 312, it is to be appreciated that the edge architecture 300 in other embodiments can include one or more additional edge devices, one or more additional configurable surfaces, and/or one or more additional servers. Accordingly, in some embodiments, the authentication module 304 can maintain information that maps one or more edge devices to one or more respective parameters (or sets of parameters). By way of example, the information can include multiple device IDs mapped to different wavelengths (e.g., mappings between: ID1 and wavelength X, ID2 and wavelength Y, ID3 and wavelength Z, etc.). In such embodiments, the server 301 can determine the mappings in a rotational manner or using some other specified scheme, such as a randomized scheme or a round robin scheme, as non-limiting examples. Such information can be stored as authentication information 107 in the database 106, for example.

FIG. 3B shows the edge architecture 300 after the authentication request 320 has been received by the server 301. In the FIG. 3B example, the authentication module 304 provides control information 322 to the surface controller 308. The control information 322 can include an indication of the one or more parameters that are to be used by the edge device 312 for receiving and/or transmitting light-based communications.

The surface controller 308 generates and sends one or more control signals 324 to the configurable surface 310 based on the control information 322. For example, the one or more control signals 324 can manipulate one or more characteristics of the configurable surface 310 such that light emitted by one or more of the light sources associated with light-based transceiver 306 of the server 301 is modified.

The light-based transceiver 306 of the server 301 transmits a signal to the edge device 312 as modulated light 326. By way of example, the signal may be a test signal and/or data generated based on a particular function (e.g., a function of the device ID and/or the one or more parameters that are to be used by the edge device 312). The modulated light 326 can then be modified by the configurable surface 310 that has been configured by the one or more control signals 324. As a non-limiting example, if the server 301 has determined that a particular wavelength of light is to be used to communicate with the edge device 312, then the configurable surface 310 modifies the modulated light 326 to generate modified light 328 corresponding to that particular wavelength.

In some embodiments, the configurable surface 316 of the edge device can be programmed such that the light-based transceiver 314 receives the modified light 328. For example, the configurable surface 316 can be programmed prior to the onboarding process so that it receives the particular wavelength of the modified light 328 and does not receive one or more other wavelengths of light, for example. As another example, the particular wavelength of light can be sent over a different communication mechanism (e.g., a wired network and/or a wireless network, such as an RF wireless network). The edge device 312 can then adjust its configurable surface 316 so that it receives that particular wavelength of light.

In some embodiments, if the edge device 312 successfully detects the modified light 328 from the configurable surface 310, then the edge device 312 is considered to have successfully passed a first stage of authentication. It is noted that the authentication process is considered to fail if the edge device 312 does not detect the modified light 328. For example, if the authentication is part of an onboarding process, then the server 301 can prevent the edge device 312 from being onboarded.

FIG. 3C shows an example of an additional authentication process that is performed in the edge architecture 300. For example, in response to the edge device 312 successfully passing the first stage of authentication (as described in conjunction with FIG. 3B), the edge device 312 can send an acknowledgment to the server 301. The term “acknowledgment” in this context and elsewhere herein is intended to be broadly construed so as to encompass, for example, any message that is sent by the edge device 312 to the server 301 to indicate that the edge device 312 successfully detected the modified light 328. In the FIG. 3C example, the acknowledgement comprises a digital key 330. In another embodiment, the acknowledgment may be sent separately from the digital key 330, for example.

As a non-limiting example, the acknowledgment can be a message sent to the server 301 to acknowledge that the edge device 312 successfully received the modified light 328.

In the FIG. 3C example, the digital key 330 is received and recovered by the light-based transceiver 306, and then provided to the validation module 302 to determine whether the digital key 330 is valid. If the digital key 330 is valid, then the edge device 312 is considered to be successfully authenticated by the server 301.

FIG. 4 shows an example of a multi-stage authentication process in an illustrative embodiment. The multi-stage authentication process can be performed by the device authentication system 105, for example.

Step 400 includes obtaining an authentication request including an identifier of a device.

Step 402 includes extracting the device identifier from the authentication request.

Step 404 includes sending control information to a surface controller (e.g., surface controller 114) for modifying a light signal. For example, the light signal can correspond to a test signal, which is modified by the one or more configurable surfaces 110.

Step 406 includes transmitting the modified light signal to the device.

Step 408 includes a test to determine whether the modified light signal was detected by the device. This determination can be based at least in part on whether the device sends an acknowledgement of the modified light signal within a particular period of time, for example.

If an acknowledgement message is not received, then step 410 includes preventing the device from being authenticated. If the result of step 408 is yes, then the process continues to step 412.

Step 412 includes obtaining a digital key from the device. In some embodiments, the digital key can be sent as an acknowledgment that the device has received the modified light signal.

Step 414 includes validating the digital key. For example, the digital key may correspond to a password or some other mechanism for verifying the authenticity of the device (or a user thereof).

Step 416 includes a test that checks whether the digital key is valid. If the result of the test is yes, then step 418 includes authenticating the device. Otherwise, step 410 is performed, which includes preventing the device from being authenticated.

It is to be appreciated that this particular process shows just one example implementation of a multi-stage authentication process, and alternative implementations of the process can be used in other embodiments.

FIG. 5 is a flow diagram of a process for device authentication using light-based communications and configurable surfaces in an illustrative embodiment. It is to be understood that this particular process is only an example, and additional or alternative processes can be carried out in other embodiments.

In this embodiment, the process includes steps 500-508. These steps are assumed to be performed by the device authentication system 105 utilizing its elements 112, 114, 116, and 118.

Step 500 includes obtaining at least one authentication request comprising at least one identifier of at least one device.

Step 502 includes generating at least one control signal to configure one or more characteristics of a configurable surface located in a physical environment based at least in part on the at least one identifier of the at least one device.

Step 504 includes emitting, in the physical environment, at least one encoded message for the at least one device using one or more light sources.

Step 506 includes modifying the emitted at least one encoded message using the configurable surface based at least in part on the at least one control signal.

Step 508 includes determining whether to authenticate the at least one device based at least in part on information transmitted by the at least one device in response to the at least one message.

The one or more characteristics of the configurable surface may include at least one of: a wavelength, a frequency, an intensity, and a polarization of the light. The method may include preventing an authentication of the at least one device in response to determining that the information is not received within a specified period of time. In some examples, the information can correspond to an acknowledgment. The information may include a digital key, and the determining may be further based on a validation of the digital key. For example, the digital key may be a password or some other mechanism for verifying the authenticity of the device or a user of the device. The process may include preventing an authentication of the at least one device in response to determining that the digital key is invalid. The at least one authentication request may be transmitted by the at least one device to gain access to one or more of a system and a service. The at least one device may correspond to an edge device in an edge computing environment. The edge computing environment may correspond to a telecommunications network. The authentication of the at least one device may be further based on respective physical locations of the at least one device and the one or more light sources. For example, a given one of the light sources can be located in a particular area associated with one or more physical barriers (e.g., walls and/or ceilings) that block light from escaping the particular area. In such an example, the authentication can be dependent on the at least one device being within the particular area.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly improve the availability and/or security of conventional authentication processes through the use of light-based communications and configurable surfaces. These and other embodiments can effectively overcome problems associated with existing testing techniques that generally rely on, for example, radio frequency waves to perform device authentication. Additionally, at least some embodiments can enhance the security of device authentication processes by controlling the range in which the light-based communications can be used for authentication, which is significantly more challenging for authentication techniques that rely on radio frequency waves, for example.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

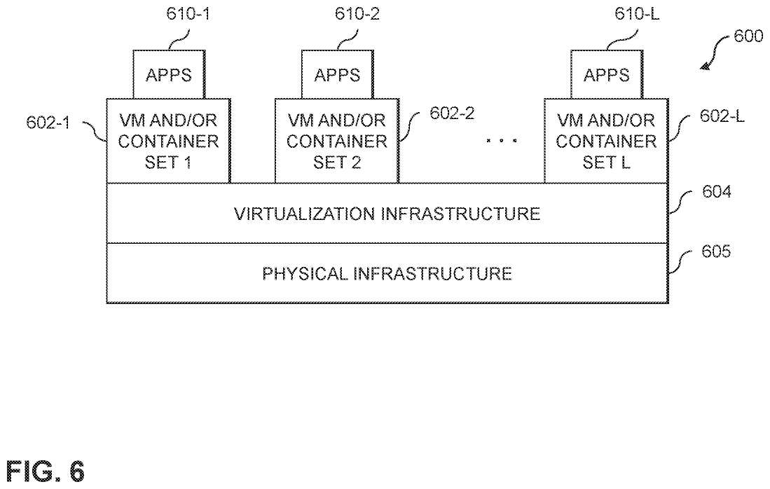

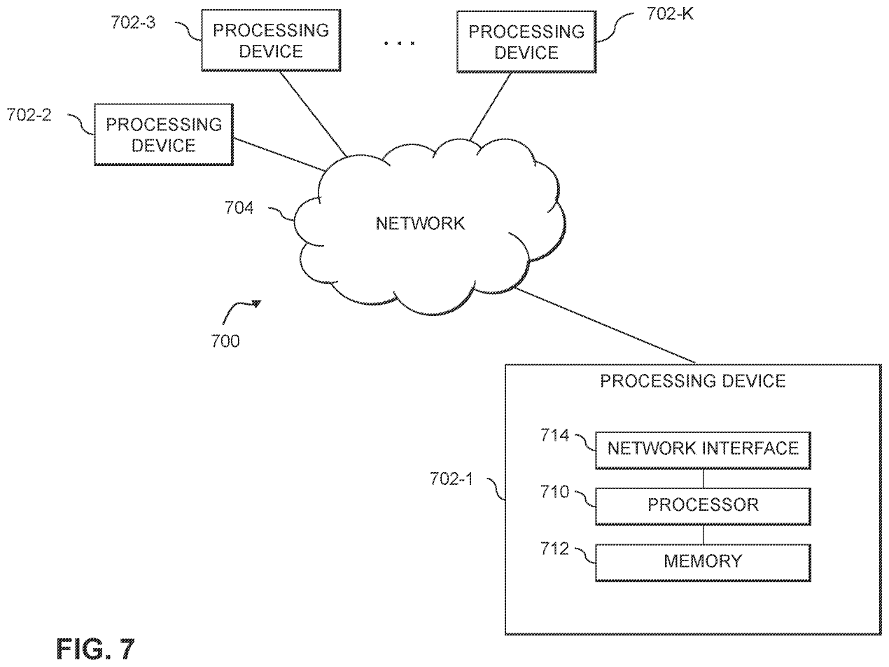

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2 . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 can comprise any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a microcontroller, an ASIC, an FPGA or other type of processing circuitry, as well as portions or combinations of such circuitry elements.

The memory 712 comprises RAM, ROM or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining at least one authentication request comprising at least one identifier of at least one device;
generating at least one control signal to configure one or more characteristics of a configurable surface located in a physical environment based at least in part on the at least one identifier of the at least one device;
emitting, in the physical environment, at least one encoded message for the at least one device using one or more light sources;
modifying the emitted at least one encoded message using the configurable surface based at least in part on the at least one control signal; and
determining whether to authenticate the at least one device based at least in part on information transmitted by the at least one device in response to the at least one message;
wherein the method is performed by at least one processing device comprising a processor coupled to a memory.

2. The computer-implemented method of claim 1, wherein the one or more characteristics of the configurable surface comprise at least one of: a wavelength, a frequency, an intensity, and a polarization of the light.

3. The computer-implemented method of claim 1, further comprising:
preventing an authentication of the at least one device in response to determining that the information is not received within a specified period of time.

4. The computer-implemented method of claim 1, wherein the information comprises a digital key, and wherein the determining is further based on a validation of the digital key.

5. The computer-implemented method of claim 4, further comprising:
preventing an authentication of the at least one device in response to determining that the digital key is invalid.

6. The computer-implemented method of claim 1, wherein the at least one authentication request is transmitted by the at least one device to gain access to one or more of a system and a service.

7. The computer-implemented method of claim 1, wherein the at least one device comprises an edge device in an edge computing environment.

8. The computer-implemented method of claim 1, wherein the authentication of the at least one device is further based on respective physical locations of the at least one device and the one or more light sources.

9. A non-transitory processor-readable storage medium having stored therein program code of one or more software programs, wherein the program code when executed by at least one processing device causes the at least one processing device:
to obtain at least one authentication request comprising at least one identifier of at least one device;
to generate at least one control signal to configure one or more characteristics of a configurable surface located in a physical environment based at least in part on the at least one identifier of the at least one device;
to emit, in the physical environment, at least one encoded message for the at least one device using one or more light sources;
to modify the emitted at least one encoded message using the configurable surface based at least in part on the at least one control signal; and
to determine whether to authenticate the at least one device based at least in part on information transmitted by the at least one device in response to the at least one message.

10. The non-transitory processor-readable storage medium of claim 9, wherein the one or more characteristics of the configurable surface comprise at least one of: a wavelength, a frequency, an intensity, and a polarization of the light.

11. The non-transitory processor-readable storage medium of claim 9, wherein the at least one processing device is further caused:
to prevent an authentication of the at least one device in response to determining that the information is not received within a specified period of time.

12. The non-transitory processor-readable storage medium of claim 9, wherein the information comprises a digital key, and wherein the determining is further based on a validation of the digital key.

13. The non-transitory processor-readable storage medium of claim 12, wherein the at least one processing device is further caused:
to prevent an authentication of the at least one device in response to determining that the digital key is invalid.

14. The non-transitory processor-readable storage medium of claim 9, wherein the at least one authentication request is transmitted by the at least one device to gain access to one or more of a system and a service.

15. The non-transitory processor-readable storage medium of claim 9, wherein the at least one device comprises an edge device in an edge computing environment.

16. An apparatus comprising:
at least one processing device comprising a processor coupled to a memory;
the at least one processing device being configured:
to obtain at least one authentication request comprising at least one identifier of at least one device;
to generate at least one control signal to configure one or more characteristics of a configurable surface located in a physical environment based at least in part on the at least one identifier of the at least one device;
to emit, in the physical environment, at least one encoded message for the at least one device using one or more light sources;
to modify the emitted at least one encoded message using the configurable surface based at least in part on the at least one control signal; and
to determine whether to authenticate the at least one device based at least in part on information transmitted by the at least one device in response to the at least one message.

17. The apparatus of claim 16, wherein the one or more characteristics of the configurable surface comprise at least one of: a wavelength, a frequency, an intensity, and a polarization of the light.

18. The apparatus of claim 16, wherein the at least one processing device is further configured:
to prevent an authentication of the at least one device in response to determining that the information is not received within a specified period of time.

19. The apparatus of claim 16, wherein the information comprises a digital key, and wherein the determining is further based on a validation of the digital key.

20. The apparatus of claim 19, wherein the at least one processing device is further configured:
to prevent an authentication of the at least one device in response to determining that the digital key is invalid.
